(19) United States
(12) Patent Application Publication
(10) Pub. No.: US 2012/0204756 A1
(43) Pub. Date: Aug. 16, 2012

(54) NON-AQUEOUS INK

(75) Inventors: Tetsuo HOSOYA, Ibaraki-ken (JP); Toshihiro ENDO, Ibaraki-ken (JP)

(73) Assignee: RISO KAGAKU CORPORATION, Tokyo (JP)

(21) Appl. No.: 13/361,758

(22) Filed: Jan. 30, 2012

(30) Foreign Application Priority Data
Feb. 14, 2011 (JP) 028057/2011

(51) Int. Cl. C09D 11/02

(52) U.S. Cl. 106/31.86

(57) ABSTRACT

A non-aqueous ink including at least a pigment and an organic solvent, wherein the organic solvent includes at least one ester solvent selected from a phosphoric acid ester solvent, a boric acid ester solvent and a silicic acid ester solvent by an amount of 50 mass % or more, and a content of a polymer component in the ink is 20 mass % or less relative to the pigment.

### BACKGROUND OF THE INVENTION

1. Field of the Invention

The present invention relates to a non-aqueous ink that is suitable for use with an inkjet recording system, and more particularly to a non-aqueous ink which provides an excellent effect of reducing or eliminating striking through.

2. Description of the Related Art

Inkjet recording systems eject a highly fluid inkjet ink from very thin head nozzles as ink particles to record an image on a sheet of printing paper, which is positioned to face the nozzles. Because of low noise and ability of high-speed printing, the inkjet recording systems are rapidly becoming widely used in recent years. As an ink for use with the inkjet recording systems, various types of so-called non-aqueous inks, which are formed by finely dispersing a pigment in a non-water-soluble solvent, have been proposed.

For example, the applicant of the present application has proposed, in U.S. Pat. No. 7,799,123 (hereinafter, Patent Document 1), a non-aqueous ink including a pigment and an organic solvent, which includes an ester solvent, a higher alcohol solvent, a hydrocarbon solvent, etc., and further including a soluble polymeric dispersant. This ink is advantageous in that it has excellent on-machine stability and is suitable for inkjet, and it can provide a printed surface that does not adhere to another printed surface printed with a PPC duplicator or a laser printer even when they are stacked in contact with each other, and thus is highly suitable for toner. Further, U.S. Patent Application Publication No. 2007/0173560 (hereinafter, Patent Document 2) discloses a non-aqueous ink including a pigment and an organic solvent, which includes a fatty acid ester solvent and/or a hydrocarbon solvent, and further including a dispersible polymeric dispersant (NAD).

Conventional pigment-dispersed non-aqueous inks use a resin or polymeric dispersant (soluble dispersant or NAD), as taught in Patent Documents 1 and 2, or directly modify the surface of the pigment with a polymer (such as grafting or microencapsulation) to ensure dispersion stability of the pigment. These approaches are to physically reduce or eliminate agglomeration of the pigment by providing steric hindrance by the polymer. In other words, these approaches attempt to improve dispersion stability of the pigment in the ink by adding a polymer component in the ink.

However, in the case where the polymer component is added in an ink, the pigment tends to penetrate into a print sheet together with the polymer component after the ink is transferred onto the print sheet because of high affinity between the pigment and the polymer component or bonding between the pigment and the polymer component. This increases tendency of the pigment to strike through the sheet. That is, in the case where dispersion of the pigment is achieved using a polymer, an attempt to increase the pigment dispersibility increases tendency of the striking through, and an attempt to reduce the tendency of the striking through decreases the pigment dispersibility, i.e., there is a trade-off between the pigment dispersibility and the reduction of the striking through.

### SUMMARY OF THE INVENTION

In view of the above-described circumstances, the present invention is directed to providing a non-aqueous ink which has excellent pigment dispersion stability and can reduce or eliminate the striking through of the ink.

An aspect of the non-aqueous ink of the invention is a non-aqueous ink including at least a pigment and an organic solvent, wherein the organic solvent includes at least one ester solvent selected from a phosphoric acid ester solvent, a boric acid ester solvent and a silicic acid ester solvent by an amount of 50 mass % or more, and a content of a polymer component in the ink is 20 mass % or less relative to the pigment.

The polymer component herein refers to a polymer having a repeating structure of monomers and a molar weight of 500 or more.

The ester solvent may preferably be phosphoric acid triester or boric acid triester.

The content of the polymer component in the ink may preferably be 5 mass % or less relative to the pigment.

It is more preferable that the ink includes substantially no polymer component.

The content of the ester solvent may preferably be in the range from 60 to 97 mass % relative to the total amount of the ink.

The non-aqueous ink of the invention includes, as the organic solvent, at least one ester solvent selected from a phosphoric acid ester solvent, a boric acid ester solvent and a silicic acid ester solvent by an amount of 50 mass % or more. This non-aqueous ink of the invention can achieve both of the dispersion stability of the pigment and the reduction of the striking through even with a content of the polymer component, which has high pigment dispersing ability, of 20 mass % or less relative to the pigment, and thus can provide high print density by the improved striking through reduction.

### DESCRIPTION OF THE PREFERRED EMBODIMENTS

A non-aqueous ink of the invention is a non-aqueous ink (which may hereinafter simply be referred to “ink”) including at least a pigment and an organic solvent, wherein the organic solvent includes at least one ester solvent selected from a phosphoric acid ester solvent, a boric acid ester solvent and a silicic acid ester solvent by an amount of 50 mass % or more, and a content of a polymer component in the ink is 20 mass % or less relative to the pigment.

Preferred examples of the ester solvent may include a phosphoric acid monoester, a boric acid monoester, a phosphoric acid diester, a boric acid diester, a phosphoric acid triester, a boric acid triester, a silicic acid ester and an alkyl silicate. More specifically, preferred examples of the ester solvent may include trimethyl phosphate, triethyl phosphate, tributyl phosphate, triisopropyl phosphate, tripropyl phosphate, triamyl phosphate, triphenyl phosphate, trimethyl borate, triethyl borate, tributyl borate, triisopropyl borate, tripropyl borate, triamyl borate, triphenyl borate, tetramethoxysilane, tetraethoxysilane, tetraproxysilane, tetrabutoxysilane and derivatives thereof.

Examples of the derivatives may include compounds with a hydrogen atom thereof substituted with a fluorine atom or an alkyl group with a carbon number of 1 to 4.

The above-listed ester solvents may be used singly or in combination of two or more species. In a case where two or more ester solvents are used in combination as appropriate, the total amount of the combined ester solvents is 50 mass % or more relative to the total organic solvent. It is more preferred that the content of the ester solvent is in the range from 60 to 97 mass % relative to the total amount of the ink.

Conventional inks need to contain a polymer component, such as a dispersant or a resin, in an amount of about 0.5 to about 30 mass % relative to the total amount of the ink (about 30 to about 200 mass % relative to the pigment) in order to provide dispersibility of the pigment. On the other hand, the ink of the invention can provide the dispersibility of the pigment by using the above-described ester solvent, and therefore can ensure sufficient dispersion stability of the pigment even with the content of the polymer component of 20 mass % or less relative to the pigment. Since the above-described ester solvent has weaker affinity for the pigment than that of polymers, the ester solvent penetrating into the print sheet does not drag the pigment after the ink is transferred onto the print sheet, unlike the case of the polymers. Therefore, almost no striking through occurs, and high density printing can be achieved as a result.

Since the amount of the polymer component in the ink of the invention includes is low, temperature dependency of ink viscosity is low, and therefore increase of the ink viscosity can be minimized even in a low temperature environment. This is a preferred characteristic as an inkjet ink. In particular, since the ink of the invention can achieve high density printing, it is suitable for a line type inkjet recording apparatus, which have to form an image in a single pass. Further, the ink of the invention allows control of the ink viscosity in an appropriate range with low power consumption even in a low temperature environment. Therefore, the ink of the invention allows controlling ink temperature in a short time even with a circulation type inkjet system, which requires temperature control of a large amount of ink, and thus is preferably usable with such a circulation type inkjet system.

The content of the polymer component in the ink is 20 mass % or less, or preferably 5 mass % or less relative to the pigment, or it is more preferable that the ink of the invention contains substantially no polymer component. “Containing substantially no polymer component” herein refers to a case where no polymer component is contained and also to a case where the polymer component is contained as an inevitable impurity, for example.

The polymer component may include a polymer component which is intentionally added to the ink, such as a polymeric dispersant or a resin, and a polymer component which is originally contained in the pigment. In a case where a polymeric dispersant is contained as the polymer component, examples of commercially available polymeric dispersants may include SOLSPERSE series (SOLSPERSE 20000, 27000, 41000, 41090, 43000 and 44000) available from The Lubrizol Corporation, JONCRYL series (JONCRYL 57, 60, 62, 63, 71 and 501) available from BASF Japan Ltd., polyvinyl pyrrolidone K-30 and K-90 available from Dai-Ichi Kogyo Seiyaku Co., Ltd., etc.

In a case where a resin is contained as the polymer component, examples of the resin may include: maleic resins, such as MALKYD NO. 31, NO. 32, NO. 33 and MALKYD NOS. 32 to 30WS available from Arakawa Chemical Industries, Ltd.; phenol resins, such as TAMANORI 751 and TAMANOL PA available from Arakawa Chemical Industries, Ltd.; styrene acrylic resins, such as JONCRYL 682 (trade name) available from BASF Japan Ltd.; ketone resins, such as HILAC 111 and 110H available from Hitachi Chemical Co., Ltd.; coumarone resins, such as ESCRON G90 and V120 available from Nippon Steel Chemical Co., Ltd.; polyvinyl formal resins, such as VINYLEC TYPE-E and TYPE-K available from Chisso Corporation; ε-caprolactam copolymers, such as NYLON 6 available from Ube Industries, Ltd.; polyvinyl butyral resins, such as ESLEC BL-1 and BL-2 available from Sekisui Chemical Co., Ltd.; polystyrenes, such as STYLAC-AS767 available from Asahi Kasei Corporation; polyacrylic acid esters, such as methyl polyacrylate; polymethacrylic acid esters, such as methyl polymethacrylate and propyl polymethacrylate; addition polymer resins, such as chlorinated polypropylene, polyvinyl acetate and maleic anhydride polymer; and condensation polymer resins, such as acrylonitrile-butadiene-styrene resin, chlorinated polypropylene, DFK resin, polyester, polyurethane and polyamide.

The organic solvent contained in the ink of the invention may totally consist of the above-described ester solvent or may include another organic solvent. Examples of the organic solvent other than the ester solvent may include water-soluble organic solvents, and may specifically include glycols, such as propylene carbonate, 1,2-butylene carbonate, ethylene carbonate, ethylene glycol, diethylene glycol, triethylene glycol, tetraethylene glycol, pentaethylene glycol, propylene glycol, dipropylene glycol and tripropylene glycol, glycerin, acetins, glycol derivatives, such as triethylene glycol monomethyl ether, triethylene glycol monobutyl ether, tetraethylene glycol monomethyl ether, tetraethylene glycol dimethyl ether and tetraethylene glycol diethyl ether, triethanolamine, 1-methyl-2-pyrrolidone, β-thioglycol and sulfolane. These water-soluble organic solvents may be used singly or in combination of two or more species.

The ink of the invention may include any of conventionally known inorganic pigments and organic pigments, as appropriate. Examples of the inorganic pigments may include titanium oxide, colcothar, cobalt blue, ultramarine, iron blue, carbon black, calcium carbonate, kaolin, clay, barium sulfate, talc and silica. Examples of the organic pigments may include insoluble azo pigment, azo lake pigment, condensed azo pigment, condensed polycyclic pigment and copper phthalocyanine pigment. These pigments may be used singly or in mixture of two or more species, as appropriate. The addition amount of the pigment may preferably be in the range from 0.5 to 20 mass % relative to the total amount of the ink.

The pigment may be used without surface treatment; however, it is more preferable to use a pigment with a polar functional group, in particular, an acidic pigment. Examples of the polar functional group may include carboxylic group, sulfonic group, hydroxyl group, amino group, imino group, aldehyde group, carbonyl group and nitro group. This type of pigment is more likely to ensure the dispersion stability. For example, with respect to the carbon black, an acidic carbon black or an acidified neutral carbon black with a pH of pigment washing water of 4.0 or less is preferred. The pH of the pigment washing water is measured according to JIS standard K5101-17-1. Specific examples of preferred acidic pigments may include carbon black MA100, MA11, MA8 and MA7 (available from Mitsubishi Chemical Corporation), RAVEN 1040 and RAVEN 1255 (available from Columbian), REGAL 400 (available from Cabot), CYANIN BLUE KRG and CYANIN BLUE 4044 (available from Sanyo Color Works, Ltd.), BRILLIANT CARMINE 6B-321 and SUPER RED BN (available from DIC), AP22 (available from Dainichiseika Color & Chemicals Mfg. Co., Ltd.), and FAST YELLOW 4190 and BY2000GT (available from DIC).

Besides the above-described components, the ink of the invention may include conventional additives. Examples of the additives may include a surfactant, such as an anionic, cationic, amphoteric or nonionic surfactant, an antioxidant, such as dibutylhydroxytoluene, propyl gallate, tocopherol, butylhydroxyanisol or nordihydroguaiaretic acid, etc.

The ink of the invention can be prepared, for example, by putting all the components at once or in fractions in a known dispersing device, such as a bead mill, to disperse the components, and filtering them with a known filtering device, such as a membrane filter, as desired.

Examples of the non-aqueous ink of the invention are shown below.

### EXAMPLES

### Preparation of Carbon Black Sample 1

In an flask provided with a stirrer, a thermometer, a nitrogen gas introducing device and a cooling tube, 10 g of carbon black (MA600 with a particle size of 20 nm, a specific surface area of 140 m²/g (JIS K6217) and a pH of 7, available from Mitsubishi Chemical Corporation), 1 g of KPS (potassium persulfate expressed by K₂S₂O₈, available from Wako Pure Chemical Industries, Ltd.) as a surface treating agent, 2 g of DEMOL NL (sodium salt of formalin β-naphthalenesulfonate condensate, available from Kao Corporation) as a pigment dispersant and 100 g of water as a solvent were put.

Then, zirconia beads (2.0 mm φ, 450 g/100 g of reaction mixture) were put in the flask, and nitrogen gas was injected while stirring to substitute the atmosphere in the flask with the nitrogen gas. The flask was set in an oil bath set at 105° C., and the mixture in the flask were stirred at 100 rpm under the nitrogen gas atmosphere to react the mixture for six hours. The resulting reaction mixture was filtered to remove the beads, and then, BUTYCENOL (tetraethylene glycol monobutyl ether, available from Kyowa Hakko Chemical Co., Ltd.) of equal mass was added to the remaining reaction mixture and the mixture was stirred. Thereafter, the content of the flask was separated by centrifugation into a solid content and a liquid content.

The separated solid content was dispersed in water and stirred at 70° C. for 12 hours to dissolve the unreacted surface treating agent in water, and then was filtered with a filter to isolate the carbon black. The resulting carbon black was dried at 100° C. for 12 hours. The resulting carbon black was analyzed by FT-IR, and the presence of COOH group and SO₃K group was confirmed. Further, the pH of the pigment washing water was measured according to JIS standard K5101-17-1 and was found to be 2.3.

### Preparation of Ink

Ink samples of Examples and Comparative Examples were prepared by premixing materials according to each composition shown in Table 1 below (the numerical values shown in Table 1 are in parts by mass) and dispersing the mixture with a retention time of about 12 minutes.

### Evaluation

### Dispersibility

Conditions of the ink samples of the Examples and the Comparative Examples immediately after dispersion were visually observed and evaluated according to the following criteria:

Good: no agglomeration/sedimentation of the pigment was observed; and
Bad: significant separation or agglomeration/sedimentation of the pigment was observed.

### Striking Through

With respect to the ink samples of the Examples and the Comparative Examples, each of the ink samples subjected to the above-described dispersibility test was transferred onto a RISO print sheet (thin type) with a bar coater, and the rear side of the print sheet was visually observed and evaluated according to the following criteria (it should be noted that this test was not carried out for the ink samples which was evaluated as “Bad” in the dispersibility test):

Excellent: almost no striking through was observed;
Good: only a low level of striking through was observed;
Acceptable: a certain acceptable level of striking through was observed; and
Bad: a significant level of striking through was observed.

### Storage Stability

Each of the ink samples of the Examples and the Comparative

Examples was put and sealed in a glass bottle and left for one week at room temperature, and then was visually observed and evaluated according to the following criteria:

Good: no agglomeration/sedimentation of the pigment was observed;
Acceptable: slight agglomeration/sedimentation of the pigment was observed; and
Bad: significant separation or agglomeration/sedimentation of the pigment was observed.

The formulation and the results of the evaluations of each ink sample are shown in Table 1.

TABLE 1

| | | | | | | | | | Comp. |
|---|---|---|---|---|---|---|---|---|---|
| | | Ex. 1 | Ex. 2 | Ex. 3 | Ex. 4 | Ex. 5 | Ex. 6 | Ex. 7 | 1 |
| Pigment | Carbon black sample 1, | 10 | 10 | 10 | 10 | | | | 10 |
| | pH 2.3 (black) | | | | | | | | |
| | CYANIN BLUE KRG (cyan) | | | | | 5.1 | | | |
| | BRILLIANT CARMINE 6B321 | | | | | | 5.1 | | |
| | (magenta) | | | | | | | | |
| | BY2000GT (yellow) | | | | | | | 5.1 | |
| Dispersant | S20000 (Lubrizol) | | | | 2 | | | | |
| Solvent | Triethyl phosphate | 90 | | | 88 | 94.9 | 94.9 | 94.9 | |
| | Isopropyl borate | | 90 | | | | | | |
| | Tetraethyl orthosilicate | | | 90 | | | | | |
| | Isopropanol | | | | | | | | 90 |
| | Dimethyl carbonate | | | | | | | | |
| | Butyl acetate | | | | | | | | |
| | Diethylene glycol | | | | | | | | |
| | Methyl oleate | | | | | | | | |
| Total | | 100 | 100 | 100 | 100 | 100 | 100 | 100 | 100 |
| Ratio of ester solvent to total solvent (%) | | 100 | 100 | 100 | 100 | 100 | 100 | 100 | 0 |
| Ratio of polymer to pigment (%) | | 0 | 0 | 0 | 20 | 0 | 0 | 0 | 0 |
| Ink viscosity (mPa · s/at 23° C., 10 Pa) | | 7.3 | 8.1 | 8.4 | 7.6 | 5.2 | 2.9 | 5.1 | — |
| Ink viscosity (mPa · s/at 5° C., 10 Pa) | | 9.3 | 10.7 | 10.9 | 10.1 | 7.9 | 4.2 | 8.3 | — |
| Evaluation | Dispersibility | Good | Good | Good | Good | Good | Good | Good | Bad |
| | Striking through | Excellent | Good | Good | Acceptable | Excellent | Excellent | Excellent | — |
| | Storage stability | Excellent | Good | Good | Good | Excellent | Good | Good | — |

| | | Comp. | Comp. | Comp. | Comp. | Comp. | Comp. | Comp. |
|---|---|---|---|---|---|---|---|---|
| | | 2 | 3 | 4 | 5 | 6 | 7 | 8 |
| Pigment | Carbon black sample 1, | 10 | 10 | 10 | 10 | 10 | 10 | 10 |
| | pH 2.3 (black) | | | | | | | |
| | CYANIN BLUE KRG (cyan) | | | | | | | |
| | BRILLIANT CARMINE 6B321 | | | | | | | |
| | (magenta) | | | | | | | |
| | BY2000GT (yellow) | | | | | | | |
| Dispersant | S20000 (Lubrizol) | | | | | 2 | 5 | 5 |
| Solvent | Triethyl phosphate | | | | | | | 85 |
| | Isopropyl borate | | | | | | | |
| | Tetraethyl orthosilicate | | | | | | | |
| | Isopropanol | | | | | | | |
| | Dimethyl carbonate | 90 | | | | | | |
| | Butyl acetate | | 90 | | | | | |
| | Diethylene glycol | | | 90 | | | | |
| | Methyl oleate | | | | 90 | 88 | 85 | |
| Total | | 100 | 100 | 100 | 100 | 100 | 100 | 100 |
| Ratio of ester solvent to total solvent (%) | | 0 | 0 | 0 | 0 | 0 | 0 | 0 |
| Ratio of polymer to pigment (%) | | 0 | 0 | 0 | 0 | 20 | 50 | 50 |
| Ink viscosity (mPa · s/at 23° C., 10 Pa) | | — | — | — | — | — | 10.1 | 9.7 |
| Ink viscosity (mPa · s/at 5° C., 10 Pa) | | — | — | — | — | — | 19.8 | 21.6 |
| Evaluation | Dispersibility | Bad | Bad | Bad | Bad | Bad | Good | Good |
| | Striking through | — | — | — | — | — | Bad | Bad |
| | Storage stability | — | — | — | — | — | Good | Good |

As shown in Table 1, the ink samples of the invention achieved good dispersion even with the significantly low polymer content, and had excellent storage stability and successfully reduced the striking through. As a result, the ink of the invention can achieve high print density. The ink samples of Comparative Example 1 to 5, where no dispersant was contained and the solvent was not the specific ester solvent of the invention, failed to achieve dispersion. Although the ink sample of Comparative Example 6 contained the dispersant, the ratio of the dispersant to the pigment was very low and thus failed to achieve dispersion. With respect to this point, the remarkable effect of the specific ester solvent of the invention can be seen by comparing the ink sample of Example 4, which contained the dispersant at the same ratio as that in Comparative Example 6, with the ink sample of Comparative Example 6. Further, although the ink sample of Comparative Example 7 contained the dispersant by an amount sufficient for dispersing the pigment, the pigment tended to penetrate into the print sheet together with the polymer component after the ink was transferred onto the print sheet, and this caused the striking through. The ink sample of Comparative Example 8 contained the specific ester solvent of the invention by an amount of 85 mass %; however, the high polymer content relative to the pigment caused the striking through.

Further, comparing the ink samples of the invention with the ink sample of Comparative Example 7, which did not contain the specific ester solvent of the invention, and the ink sample of Comparative Example 8, which contained the specific ester solvent of the invention by an amount of 85 mass % but had the high polymer content relative to the pigment, the ink samples of the invention had lower ink viscosity values under the usual environment and the low temperature environment, and thus are suitable as an inkjet ink.

As described above, the ink of the invention, which includes, as the organic solvent, at least one ester solvent selected from a phosphoric acid ester solvent, a boric acid ester solvent and a silicic acid ester solvent by an amount of 50 mass % or more, can provide a non-aqueous ink that can achieve both of the dispersion stability of the pigment and the reduction of the striking through even with a content of 20 mass % or less of the polymer component, which has high pigment dispersing ability.

What is claimed is:

1. A non-aqueous ink comprising at least a pigment and an organic solvent, wherein the organic solvent comprises at least one ester solvent selected from a phosphoric acid ester solvent, a boric acid ester solvent and a silicic acid ester solvent by an amount of 50 mass % or more, and a content of a polymer component in the ink is 20 mass % or less relative to the pigment.

2. The non-aqueous ink as claimed in claim 1, wherein the ester solvent is a phosphoric acid triester or a boric acid triester.

3. The non-aqueous ink as claimed in claim 1, wherein the content of the polymer component in the ink is 5 mass % or less relative to the pigment.

4. The non-aqueous ink as claimed in claim 2, wherein the content of the polymer component in the ink is 5 mass % or less relative to the pigment.

5. The non-aqueous ink as claimed in claim 1 which includes substantially no polymer component.

6. The non-aqueous ink as claimed in claim 2 which includes substantially no polymer component.

7. The non-aqueous ink as claimed in claim 3 which includes substantially no polymer component.

8. The non-aqueous ink as claimed in claim 4 which includes substantially no polymer component.

9. The non-aqueous ink as claimed in claim 1, wherein the content of the ester solvent is in the range from 60 to 97 mass % relative to a total amount of the ink.

10. The non-aqueous ink as claimed in claim 2, wherein the content of the ester solvent is in the range from 60 to 97 mass % relative to a total amount of the ink.

11. The non-aqueous ink as claimed in claim 3, wherein the content of the ester solvent is in the range from 60 to 97 mass % relative to a total amount of the ink.

12. The non-aqueous ink as claimed in claim 4, wherein the content of the ester solvent is in the range from 60 to 97 mass % relative to a total amount of the ink.

13. The non-aqueous ink as claimed in claim 5, wherein the content of the ester solvent is in the range from 60 to 97 mass % relative to a total amount of the ink.

14. The non-aqueous ink as claimed in claim 6, wherein the content of the ester solvent is in the range from 60 to 97 mass % relative to a total amount of the ink.

15. The non-aqueous ink as claimed in claim 7, wherein the content of the ester solvent is in the range from 60 to 97 mass % relative to a total amount of the ink.

16. The non-aqueous ink as claimed in claim 8, wherein the content of the ester solvent is in the range from 60 to 97 mass % relative to a total amount of the ink.

17. The non-aqueous ink as claimed in claim 3 for use as an inkjet ink.

18. The non-aqueous ink as claimed in claim 4 for use as an inkjet ink.

19. The non-aqueous ink as claimed in claim 8 for use as an inkjet ink.

20. The non-aqueous ink as claimed in claim 16 for use as an inkjet ink.
